(19) United States
(12) Patent Application Publication
(10) Pub. No.: US 2026/0357615 A1
(43) Pub. Date: Nov. 12, 2026

(54) DOOR LOCK INDICATOR FOR A GATE ASSEMBLY ON A RAILROAD HOPPER CAR AND RELATED METHOD FOR OPERATING SAME

(71) Applicants: MINER ENTERPRISES, INC., GENEVA, IL (US); POWERBRACE CORPORATION, KENOSHA, WI (US)

(72) Inventors: Christopher C. GAYDOS, Burlington, WI (US); Reilly J. FLYNN, Milwaukee, WI (US); John W. HARBST, Bartlett, IL (US); Joseph M. INGRAHAM, Shabbona, IL (US)

(21) Appl. No.: 19/199,888

(22) Filed: May 6, 2025

(51) Int. Cl. E05B 41/00; B61D 7/02; E05B 17/10

(52) U.S. Cl. CPC E05B 41/00; B61D 7/02; E05B 17/10

(57) ABSTRACT

A door lock indicator for visually indicating a condition of a door lock on a gate assembly of a railcar. The railcar gate assembly has a sliding door movable between an open and closed positions. In one embodiment, the door lock indicator includes a first instrumentality arranged in a fixed position on the gate assembly and a second pivotally movable instrumentality. The first and second instrumentalities have an interengaging relationship with each other when the door lock is in a locked condition. Viewable portions of the first and second instrumentalities have a non-interengaging relationship with each other in response to the door lock being pivotally moved to an unlocked condition. A drive mechanism is operably coupled to and positively pivots the second instrumentality relative to the first instrumentality as a function of the locked/unlocked condition of the door lock.

### FIELD OF THE INVENTION DISCLOSURE

The present invention disclosure generally relates to railroad hopper cars and, more particularly, to a railcar door lock indicator and related method for operating same

### BACKGROUND

Railroad hopper cars are commonly used to economically transport commodities between distant geographic locations. Such cars are typically used to transport aggregate, iron ore and like granular commodities or materials which can be rapidly discharged from the hopper car through gate assemblies mounted in material receiving relation relative to standard openings on a bottom of the hopper car. Each gate assembly typically includes a frame with a bottom opening. A door is slidably movable on the frame and a drive mechanism is provided for moving the door between closed and open positions. In a closed position, the door inhibits discharge of material from the hopper car. When the door is opened, material is gravitationally discharged through the respective bottom opening.

As the hopper car moves between locations it is continually subject to vibrations and other movements which can and do cause the door on one or more of the gate assemblies to inadvertently move from the closed position toward an open position. Moreover, in railyards the hopper cars are subjected to bumping against each other during assembly of a train consist. Because “time is money”, the speeds at which such cars are joined has only increased in recent years only adding to the sliding forces acting on the doors on each gate assembly. These bumping actions can also cause the doors on the gate assemblies to inadvertently move toward an open position. Of course, inadvertent movement of the doors on the multitude of gate assemblies comprising the train consist can result in the loss of a significant amount of material from the hopper car during their transport between distant locations.

Accordingly, most of today's hopper cars are equipped with some type of lock arranged in operable combination with the sliding door of each gate assembly to releasably maintain the sliding door of the respective gate assembly in a closed position during transport and make-up of the train consist. Generally, such lock is operable in either a locked condition, wherein said lock maintains the sliding door of the respective gate assembly in a closed position whereby inhibiting the discharge of material from the car, and an unlocked condition. When the lock is in a locked condition and an operator mistakenly attempts to open the slide door, significant damage can result to the lock, the drive mechanism used to condition the lock, the door, and related parts on the gate assembly and car. In the unlocked condition, the lock permits the sliding door of the respective gate assembly to be positively moved toward the open position whereby permitting discharge of material from the hopper car. The lock typically moves along a predetermined path of travel as it moves between conditions.

As will be appreciated, the locked/unlocked condition of the door lock on a hopper railcar having a sliding door is an important concern. Due to the construction of most hopper railcar, the lock for releasably maintaining the sliding door associated with each gate assembly are inconveniently located beneath the hopper car and are typically difficult to readily view from either side of the car. Thus, it is often difficult to evaluate whether the door lock is in a locked or an unlocked condition. Accordingly, and to avoid an inadvertent and costly loss of materials through a partially open slide door and/or damages to the lock and related railcar components, a suitable device or person must determine whether the door lock has been moved from the locked position between locations prior to purposeful emptying the contents or material from the car.

Thus, there is a need and continuing desire for a simplistic door lock indicator for visually indicating an unlocked/locked condition of a door lock on a railroad hopper car having a sliding door movable between an open position and a closed position as a function of the condition of the door lock.

### SUMMARY

One aspect of this invention disclosure relates to a door lock indicator for visually indicating an unlocked/locked condition of a door lock on a gate assembly of a railcar. Each gate assembly on the railcar has a sliding door movable between an open position and a closed position as a function of the condition of the door lock. In one embodiment, the door lock indicator includes a first instrumentality arranged in a fixed position on the gate assembly, and a second pivotally movable instrumentality on the gate assembly. The first instrumentality defines a fixed plane. In one embodiment, portions of the first and second instrumentalities have an interengaging relationship with each other when the door lock is in a locked condition. As used herein and throughout, the phrase “interengaging relationship” means and refers to having a viewable portion of the second instrumentality penetrate or permeate the fixed plane defined by the first instrumentality. When the door lock is in an unlocked condition, those same portions of the first and second instrumentalities have a clearly viewable non-engaging relationship with each other. A drive mechanism is operably coupled to and positively pivots the second instrumentality relative to the first instrumentality as a function of the locked/unlocked condition of the door lock. In effect, the present invention disclosure provides In effect, the present invention disclosure provides a signal amplifier through mechanical means regarding the current condition of a door lock on a railroad hopper car. In effect, the present invention disclosure provides a signal amplifier through mechanical means regarding the current condition of a door lock on a railroad hopper car.

In a preferred embodiment, the second instrumentality of the door lock includes an appendage movable into and out of the interengaging relationship with the first instrumentality to visually indicate the condition of the door lock on the railcar. A highly visible coloration is provided on the appendage of the second instrumentality to enhance the visibility thereof.

In one form, the first instrumentality fixedly extends from a frame on the gate assembly and has a free end. The drive mechanism is operably coupled to and positively pivots the second instrumentality relative to the first instrumentality as a function of the locked/unlocked condition of the door lock. Preferably, the drive mechanism for the door lock also serves to control movement of the door on the gate assembly.

According to another aspect of this invention disclosure, there is provided a door lock indicator for providing a visual indication of a condition of a door lock on a gate assembly for a hopper railcar. The rail car has a hopper defining a discharge opening through which lading is discharged from the hopper. As is conventional, the gate assembly includes a frame and a door which is slidably movable on the frame, under the operable influence of a manually operated and rotatable drive mechanism. The door slides between a closed position, wherein the door blocks the discharge of lading through the discharge opening, and an open condition, wherein lading is permitted to be discharged from the hopper through the discharge opening. The door lock releasably maintains the door in the closed position so as to inhibit inadvertent discharge of material from the hopper. When the door lock is manually moved to an unlocked condition, the door can be moved toward an open position.

According to this aspect of the invention disclosure, the door lock indicator includes a first instrumentality extending from the frame of the gate assembly. The first instrumentality defines a fixed plane. The door lock indicator also includes second instrumentality which is pivotally movable in response to rotation of the manually operated and rotatable drive mechanism. The second instrumentality is pivotal between a first position, wherein an indicator portion of the second instrumentality permeates or protrudes through the plane defined by the first instrumentality to clearly indicate when the door lock is in the locked position, and a second position wherein the indicator portion of the second instrumentality is removed from the plane of the first instrumentality to clearly indicate the door lock is in the locked position.

In accordance with this aspect of the invention disclosure, the door lock indicator further includes a highly visible coloration disposed on the indicator portion of the second instrumentality to enhance the visibility thereof. Preferably, the first instrumentality fixedly extends from the gate assembly frame and has a free end.

In accordance with this aspect of the invention disclosure, the door lock indicator further includes an electrical system which, in effect, provides a signal amplifier through mechanical means regarding the current condition of a door lock on a railroad hopper car. In one form, the electrical system includes an electrically powered illuminable indicator arranged on the railcar. The electrical system is configureded to indicate whether the door lock is in the locked condition or the unlocked condition. The electrical system includes electrical circuitry for operating the illuminable indicator as a function of the pivotal position of the indicator portion on the second instrumentality.

In accordance with still another aspect of this invention disclosure, there is provided a method of indicating the status of a door lock on a railcar gate assembly having a horizontally slidable door which moves between open and closed positions on a railcar. The door lock is displaceable between a locked condition, wherein the door lock inhibits the gate assembly door from sliding toward the open positron, and an unlocked condition. In the unlocked condition, the door lock permits the gate assembly door to slidably move toward the open position.

In accordance with this aspect of the invention disclosure the process involves: displacing the door lock from a locked condition in timed relation with moving the door from the closed position through a drive mechanism operably coupled to the door. This process furthermore involves: providing a first instrumentality on a frame of the gate assembly so as to define a fixed plane. Furthermore, the process involves the step of: pivotally extending and retracting a flag portion of a second instrumentality from one side of the fixed plane to an opposite side of the fixed plane in response to displacement of the door lock and whereby rendering a clearly visible indication of the door lock condition.

The process further involves the step of: providing the second. instrumentality with an appendage movable into and out of an interengaging or interwoven relationship with the first instrumentality to visually indicate the unlocked/locked condition of the door lock on the railcar. Preferably, the process further involves the step of: providing a highly visible coloration on the appendage of the second instrumentality to enhance the visibility thereof. According to a preferred process, the first instrumentality fixedly extends from a frame of the gate assembly and has a free end. In one form, the preferred process also includes the step of: operably coupling the drive mechanism to and positively pivoting the second instrumentality relative to the first instrumentality as a function of the locked/unlocked condition of the door lock while concurrently operating the door lock.

Preferably, the method of indicating status of a door lock on a railcar with a gate assembly further involves the step of: providing an electrically powered illuminable indicator on the railcar for indicating whether the door lock is in the locked condition or the unlocked condition. Wherein, this step also involves providing electrical circuitry operated as a function of the pivotal position of the second instrumentality and connected to the illuminable indicator. In one form, the process further involves: providing a solar energy panel on the railcar to power a battery connected to the illuminable indicator and circuitry electrically powering the illuminable indicator.

### DESCRIPTION OF THE DRAWINGS

FIG. 1 is side elevational view of one form of a railroad hopper car having mounted thereon a series of gate assemblies which embody teachings and principals of the present invention disclosure;

FIG. 2 is a top plan view taken along line 2-2 of FIG. 1 showing one form of gate assembly embodying principals and teachings of this invention disclosure;

FIG. 3 is a perspective view of the gate assembly illustrated in FIG. 2;

FIG. 4 is an end view of the gate assembly illustrated in FIG. 2;

FIG. 5 is an enlarged partial sectional view taken along line 5-5 of FIG. 2 showing one form of lock assembly for the gate assembly in a locked condition;

FIG. 6 is an enlarged partial sectional view similar to FIG. 5 but showing the lock assembly for the gate assembly in an unlocked condition;

FIG. 7 is an enlarged partial sectional view taken along line 7-7 of FIG. 2 showing one form of a mechanical system for operating the lock assembly of the gate assembly shown in FIGS. 5 and 6;

FIG. 8 is a view similar to FIG. 7 but from an opposite side of the gate assembly and showing one form of door lock indicator apparatus and the mechanical system for operating the lock assembly of the gate assembly;

FIG. 9 is a view similar to FIG. 8 showing the exemplary embodiment of the door lock indicator apparatus when the door lock of the gate assembly is moved to an unlocked condition; and

FIG. 10 is a schematic representation of one form of electrical circuitry which can be arranged in combination operable combination with the present invention disclosure.

### DETAILED DESCIPTION

While the present invention is susceptible of embodiment in multiple forms, there is shown in the drawings and will hereinafter be described preferred embodiments of the invention disclosure, with the understanding the present disclosure sets forth exemplifications of the invention which are not intended to limit the invention disclosure to the specific embodiments illustrated and described.

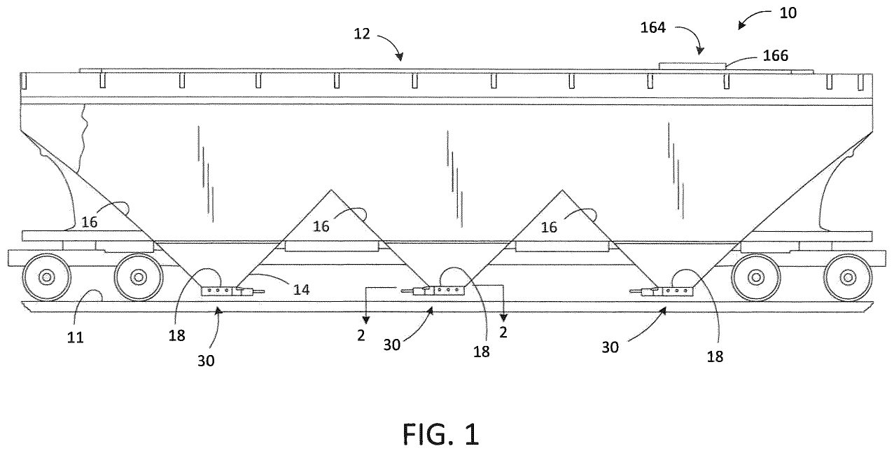

Referring now to the drawings, wherein like reference numerals indicate like parts throughout the several views, there is schematically shown in FIG. 1 a railroad hopper car, generally indicated by numeral 10, and which transports lading such as grain and the like between sometimes distant locations over conventional rails 11. Although hopper-type railcars can have a variety of configurations, they generally have a walled enclosure or hopper 12. A bottom 14 of car 10 can also take a variety of configurations. Suffice it to say, in the exemplary embodiment, the bottom 14 of the hopper 12 is provided with a plurality of longitudinally spaced funnel shaped chutes 16 between opposed ends of the hopper 12.

As shown in FIG. 1, a lower end of each hopper chute 16 terminates in a discharge opening 18 through which the lading is gravitationally discharged from car 10. A discharge gate assembly 30 is arranged in material receiving relation relative to each standard opening 18 on the hopper 12 to control the discharge of commodity/lading from the railcar 10. The discharge gate assembly 30 shown by way of example in the drawings is preferably of the type sold by Miner Enterprises, Inc. of Geneva, Illinois under Model No. MKE10200. It should be appreciated, however, the teachings and principals of this invention disclosure are readily and equally applicable to other discharge gate assemblies without detracting or departing from the true spirit and concept of this invention disclosure. In this exemplary embodiment, each gate assembly 30 on the railcar is substantially similar, thus, only one gate assembly will be described in detail.

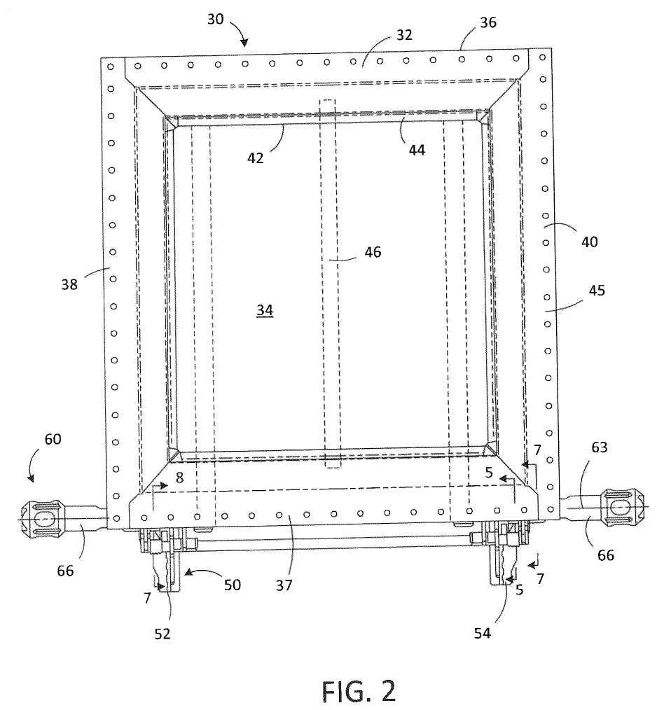

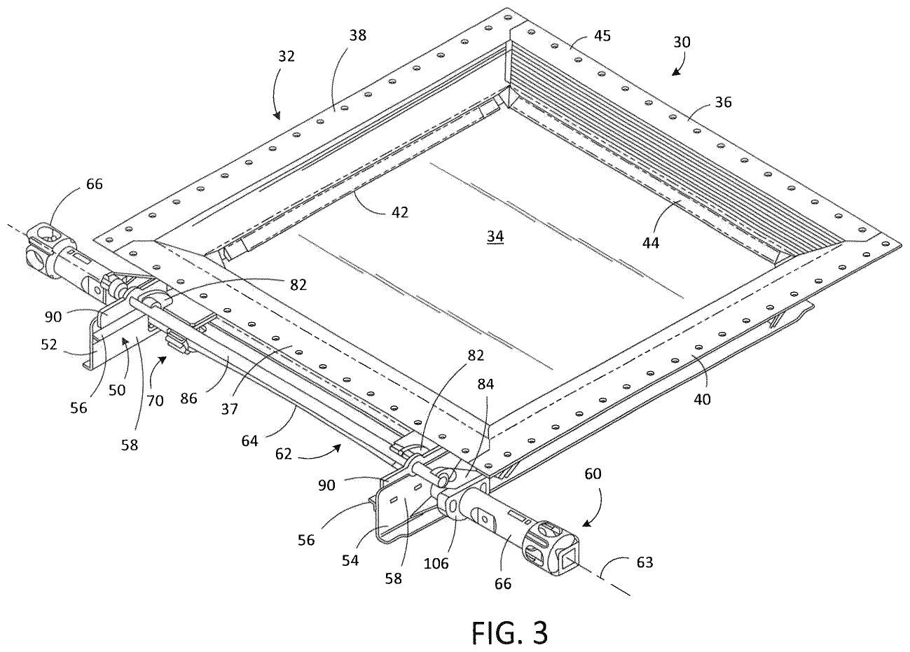

As shown in FIGS. 2 and 3, each gate assembly 30 includes a rigid frame 32. Gate assembly 30 also includes a door 34 which, as discussed below, is selectively movable between a closed position, wherein the door 34 blocks the discharge opening 18 (FIG. 1), and an open position, wherein commodity/lading is allowed to gravitationally pass or be discharged from hopper 12 (FIG. 1). Preferably, the door 34 moves in a single generally horizontal path of travel extending parallel to the length of the car 10 to control the gravitational discharge of commodity from the hopper 12 of car 10 (FIG. 1).

In the illustrated embodiment, the gate assembly frame 32 includes a rigid front wall 36, a rigid back wall 37 spaced from and extending generally parallel to the front wall 36, and a pair of generally parallel, rigid and laterally spaced side walls 38 and 40 joined or coupled to the front and back walls 36 and 37, respectively whereby rendering a generally rectangular configuration to the frame 32. From an upper end thereof, each of the front wall 36, the rear wall 37 along with the side walls 38 and 40 slant downwardly toward an opening 42 for the gate assembly 30. It is through the opening 42 that material gravitationally passes when the gate assembly 30 is arranged in material receiving relation with the discharge opening 18 on the railcar hopper 12 (FIG. 1).

Toward an upper end thereof, each wall 36, 37, 38 and 40 of gate assembly 30 has a mounting section 45 configured to facilitate securement of the gate assembly toward the bottom of each hopper chute 16 (FIG. 1). As is well known, there are numerous ways and means for securing a gate assembly toward the lower end of each chute 16 on the railcar hopper 12 including, but not limited to reconfiguring and/or redesigning the mounting section 45 on each wall 36, 37, 38 and 40 of gate assembly 30.

As shown in FIGS. 2 and 3, conventional seal structure 44 is preferably carried by the gate assembly frame 32 adjacent the opening 42 for inhibiting contaminants, moisture, debris and insect infiltration from passing between the frame 32 and door 34. In the illustrated embodiment, seal structure 44 is arranged on the frame 32 relative to a periphery of the door 34 when door 34 is in the closed position. Seal structure 44 is of a conventional design well known in the art of railcar gate assemblies and can take different designs than that illustrated for exemplary purposes without detracting or departing from the spirit and scope of this invention disclosure.

In the illustrated embodiment, and to facilitate the discharge of commodity from the car 10 (FIG. 1) and through gate assembly 30, the opening 42 of gate assembly 30 preferably includes one or more rails 46 for supporting the door 34. Each rail 46 preferably extends between and is rigidly secured to the front and rear walls 36 and 37, respectively, of the gate assembly frame 32 for supporting the door 34. Suffice it to say, the rails 46 extend in the direction of the movement of door 34. Preferably, each rail 46 has an UHMW material secured to an upper edge thereof to promote sliding movements of the door 34 thereacross. It is within the scope of this invention disclosure, however, for other suitable designs and/or materials to be used to support the door 34 for sliding movements from an underside thereof.

As shown in FIGS. 2 and 3, and as known in the art, projecting outwardly from the rear wall 37 and extending in the direction the door 34 moves toward an open position, gate assembly frame 32 further includes structure 50 for supporting the door 34 as it moves toward an open position. Support structure 50 includes a pair of laterally spaced and generally parallel frame extensions 52 and 54 which longitudinally extend outwardly past the rear wall 37 and parallel to the walls 38 and 40 of frame 32. Preferably, the frame extensions 52, 54 are laterally spaced apart the same distance from each other as are portions of the side walls 38 and 40 of frame 32. In one form, the frame extensions 52, 54 are, at least partially, formed integral with the side walls 38 and 40 of the gate assembly frame 32.

When viewed from a rear end of the gate assembly 30, the frame extensions 52, 54 are mirror images of each other. Accordingly, only frame extension 52 will be described in detail. As shown in FIG. 3, and as is conventional, each frame extension 52, 54 projecting past the rear wall 37 supports the door 34 when it is moved to an open position. Each extension 52, 54 extends generally parallel to the direction of movement of the door 34 toward the open position for a distance sufficient to support an open door 34. Structure 56 on each extension 52, 54 is disposed beneath a lower surface 35 of door 34 when the door 34 is moved to an open position. Each frame extension 52, 54 further includes a generally vertical, free ended wall portion 58 (FIG. 3) disposed to opposed side edges of the door 34.

The gate assembly 30 further includes a manually actuated door operating mechanism 60. In a preferred embodiment, the door operating mechanism includes an operating shaft assembly 62 mounted for rotation about a fixed axis 63. The fixed axis 63 of the operating shaft assembly 62 is preferably disposed in spaced generally parallel relationship from the rear wall 37 (FIG. 3) of the gate assembly frame 32. The operating shaft assembly 62 is operably coupled or connected to door 34 such that rotation of the door operating shaft assembly 62 is transmuted into linear movement of the door 34.

The door operating shaft assembly 62 of mechanism 60 extends transversely across and, in the illustrated embodiment, beneath the path of movement of door 34. The door operating shaft assembly 62 has opposed ends which, after the gate assembly 30 is secured to car 10, are operator accessible from either side of car 10 to move the door 34 between closed and open positions.

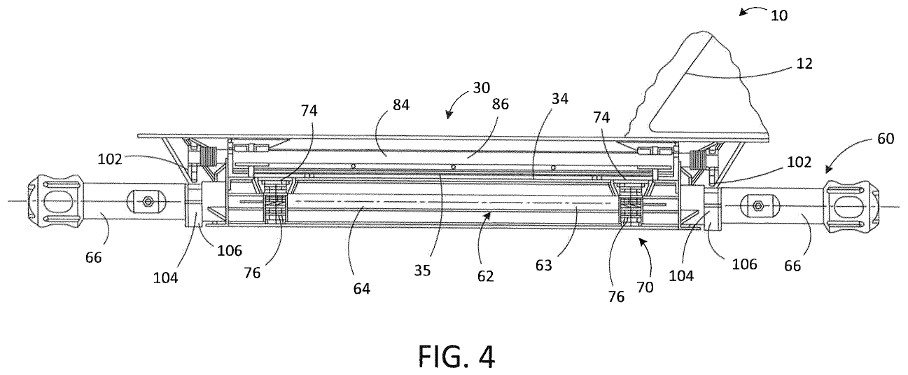

Turning to the exemplary embodiment shown in FIGS. 3 and 4, the operating shaft assembly 62 preferably includes an elongated operating shaft 64 rotatable about axis 63 with operating handles or capstans 66 connected to opposite ends thereof. As is known, the operating handles 66 rotatably mount the operating shaft assembly 60 to the gate assembly frame 32. In a most preferred form, the capstans or operating handles 66 are releasably secured to opposed ends of shaft 64.

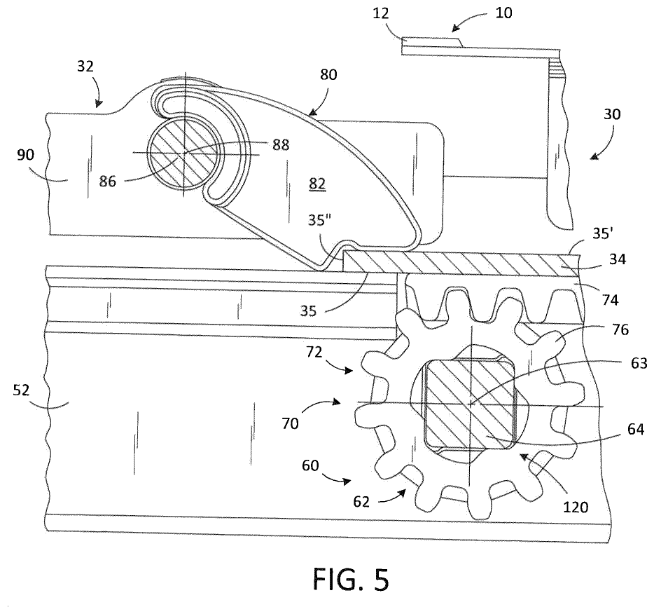

The door operating mechanism 60 further includes a drive mechanism 70 for operably coupling the operating shaft assembly 62 to the door 34. In the embodiment illustrated by way of example in FIG. 5, drive mechanism 70 includes a conventional rack and pinion assembly 72. In a preferred embodiment, assembly 72 includes a pair of laterally spaced racks 74 fixed to the lower surface 35 of door 34. A pair of laterally spaced pinions 76 are slidably received about and rotate conjointly with shaft 64 and are arranged in intermeshing engagement with the racks 74 so as to transmute rotational movements of the operating shaft assembly 62 to linear movements of the door 34.

Movement of the door 34 along its fixed path of movement Is influenced by a lock assembly 80 (FIG. 5). The purpose of the lock assembly 80 is to maintain the door 34 of the gate assembly 30 in a releasably closed condition and against inadvertent movement toward an open position until the lock assembly 80 is purposefully released by the operator. With the present invention disclosure, and in compliance with AAR Standards, lock assembly 80 is preferably configured such that it is initially released in timed response to operation of the door operated mechanism 60 automatically followed by movement of the door 34 toward an open position. That is, unlatching of the lock assembly 80 and opening of the door 34 are preferably affected in sequential order relative to each other and in response to rotation of the door operating mechanism 60.

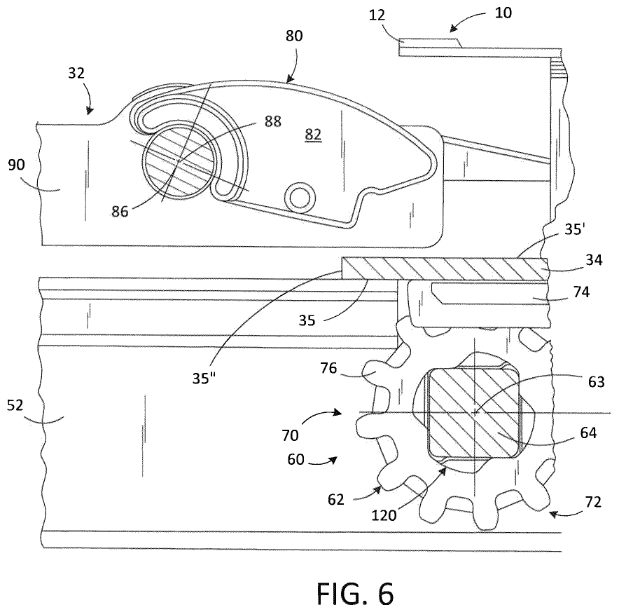

There are numerous well-known designs for affecting release of the lock assembly 80 and opening the door 34 in sequential order relative to each other and in response to rotation of the door operating mechanism 60. FIGS. 5 and 6 illustrate but one conventional design for affecting release of the lock assembly 80 and opening the door 34 in sequential order relative to each other and in response to rotation of the door operating mechanism 60. It should be appreciated; however, other designs for affecting release of the lock assembly 80 and opening the door 34 in sequential order relative to each other and in response to rotation of the door operating mechanism 60. are equally applicable without detracting or departing from the true spirit and concept of this invention disclosure.

In the embodiment set forth by way of example in FIGS. 5 and 6, lock assembly 80 is designed as a subassembly and can be beneficially fabricated independent of the gate assembly frame 32 and subsequently added thereto. Lock assembly 80 includes a stop/lock 82 mounted for movement between a first, locked position (FIG. 5), wherein stop 82 is disposed in the path of movement of and inhibits inadvertent movement of the door 34 from the closed position toward the open position, and a second, unlocked position (FIG. 6), wherein stop 82 is removed from the path of movement of the door 34. Besides being gravitationally urged into engagement with the door 34, in a preferred embodiment, stop/lock 82 is urged into positive engagement with the door 34 to inhibit inadvertent release of the lock assembly 80 as the railcar travels between locations.

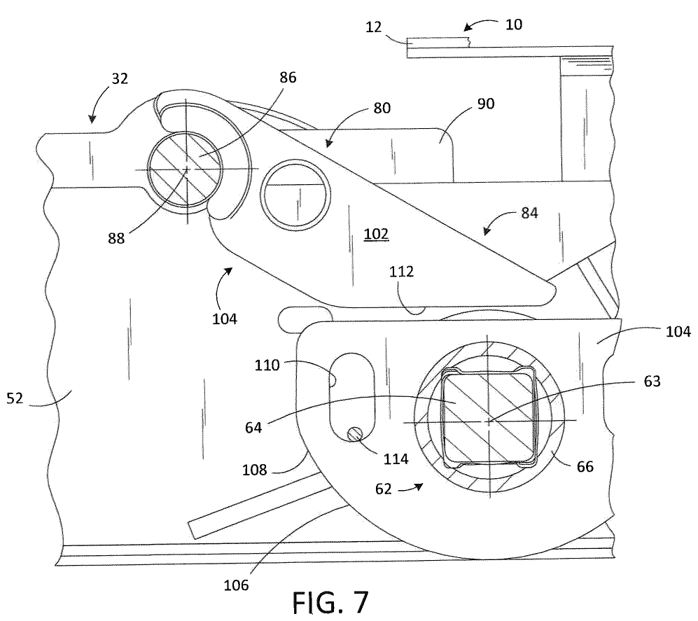

In one form, the lock assembly 80 further includes a mechanical system 84 (FIG. 7) for moving the stop 82 (FIGS. 5 and 6) between the first and second positions in timed sequential movement relative to movement of the door 34 toward the open position. In the embodiment illustrated by way of example in FIG. 7, the mechanical system 84 includes a rockshaft 86 with the stop 82 (FIGS. 5 and 6) being secured for rocking movement therewith.

Returning to FIG. 5, after lock assembly 80 is secured to gate assembly frame 32, shaft 86 is preferably arranged above the upper surface 35′ of the door 34 and generally parallel thereto. Shaft 86 is mounted for oscillatory movement about a fixed axis 88 extending generally parallel to axis 63 about which operating shaft assembly 62 rotates. In one form, a pair of laterally spaced brackets 90 (with only one being shown in FIGS. 5, 6 and 7) are secured to and extend upwardly from the respective frame extension 52, 54 (FIGS. 2 and 3) to mount the rockshaft 86 to the gate assembly frame 32. Preferably, when the lock subassembly 80 is secured to the gate assembly frame 32, the rockshaft 86 thereof is disposed above and downstream of a rearmost edge 35″ of the door 34 (FIG. 5), when the door 34 is in the closed position to promote visualization of the lock assembly 80 relative to gate 34.

Preferably, and as illustrated in FIG. 5, when the door 34 is closed, the lock/stop 82 depends angularly downward from the rockshaft 86 and a free end of the stop 82 extends toward and into positive engagement the door 34. Preferably, the free end of stop 82 is configured to releasably engage an edge 35″ of the door 34 while limiting angular movement of the stop 82 there past. By this design, and when stop 82 engages the door 34, a wedging action is preferably created or established. In a preferred form, the rockshaft 86 is inhibited against axial shifting movements along axis 88 by any suitable means.

As shown in FIG. 7, and as is known, the mechanical system 84 preferably operates the lock assembly 80 in timed sequence with movement of the door 34. In the illustrated embodiment, the mechanical system 84 further includes at least one cam follower 102 secured to and radially extending from rockshaft 86. The free end of the follower 102 is adapted to cooperate with cam structure 104 on the operating shaft assembly 62 whereby the stop/lock 82 of the lock assembly 80 (FIGS. 5 and 6) will be positively displaced relative to the path of and in timed relation relative to movement of the door 34.

In the embodiment shown by way of example in FIG. 7, the mechanism 84 for operating the lock assembly 80 and displacing the lock/stop 84 (FIGS. 5 and 6) preferably includes an actuating member or cam 106 provided toward the opposed ends of the mechanical system 83 on each side of the gate assembly frame 32. In the illustrated embodiment, the operating cam 106 is preferably arranged in combination with each operating handle or capstan 66 of the operating shaft assembly 62. Such design increases the potential throw or movement of the lock assembly 80 (FIGS. 5 and 6) while allowing the cam follower 102 of the mechanical system 100 to be advantageously disposed adjacent to the gate assembly frame 32. In the embodiment shown by way of example in FIG. 4, another cam follower 102 and associated cam structure 104 is provided toward the other end of the mechanical system 84 and operating shaft assembly 62.

The cam structure at each end of the operating shaft assembly 62 is preferably identical. As such, only one actuating member or cam 104 will be described in detail. As shown by way of example in FIG. 7, each cam 104 is preferably formed as an integral part of the handle or capstan 66 on shaft assembly 84 and includes a peripheral surface 108. Notably, at least a portion of each cam 106 is larger in diameter and extends radially outward from that portion of the operating handle 66 preferably joined thereto. For purposes to be described below, each actuating member or cam 104 defines a throughbore or slot 110, having a closed margin, arranged in radially spaced relation relative to the rotational axis 63 of the operating shaft assembly 62 to promote arrangement of a tamper seal 114 (FIG. 7) in only one position of the lock assembly 80. Along its underside, the cam follower 102 preferably includes a cam engaging surface 112 configured to inhibit the follower 102 from binding against the peripheral surface 108 of the cam 106.

Returning to the embodiment illustrated by way of example in FIG. 6, the drive mechanism 70 for the gate assembly 30 is preferably configured with a lost motion mechanism 120 operably disposed between the operating shaft assembly 62 and the mechanical system 84 (FIG. 7) for operating the lock assembly 80 to effect sequential movement of the lock assembly stop 82 and the door 34 in predetermined timed relation relative to each other. The purpose of the lost motion mechanism 120 is to permit the operating shaft assembly 62 to rotate about an angle of free rotation without corresponding movement of the door 34. As used herein, the term “free rotation” refers to that rotation of the operating shaft assembly 62 suitable to unlatch the lock assembly 80 from the door 34 prior to effecting displacement of the door 34 toward an open position. As mentioned, the lost motion mechanism 120 can take different designs from that shown for exemplary purposes without detracting or departing from the spirit and scope of this invention disclosure.

When the door 34 of the gate assembly 30 is to be purposefully moved from its closed position (FIG. 5), the operating shaft assembly 62 is purposefully rotated about axis 63. Comparing FIGS. 5 and 6, and upon initial rotation of the door operating mechanism 60, the lost motion mechanism 120 permits free rotation of the operating shaft assembly 62 without corresponding linear movement of the door 34.

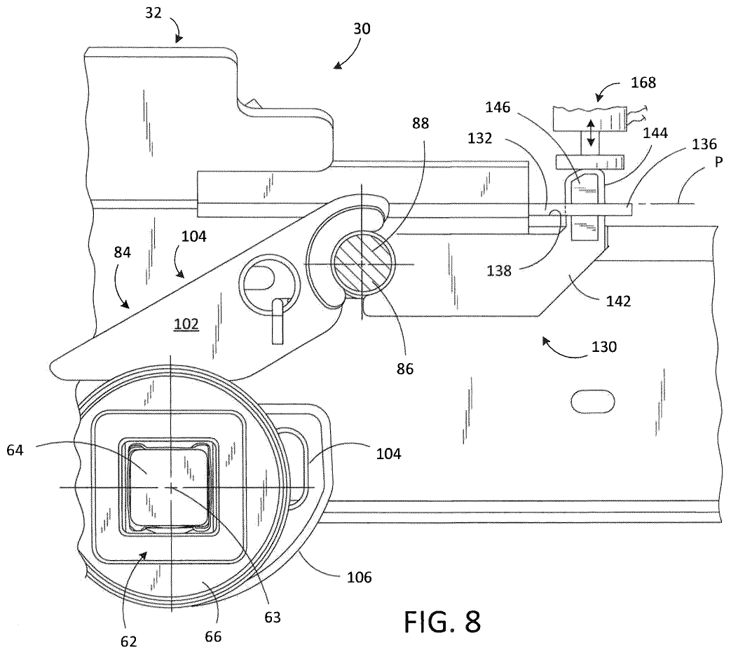

Turning to FIG. 8, it is during this free rotation of the operating shaft assembly 62 that the cam follower 102 is displaced by the rotating cam 106 thus causing the rockshaft 86 of the mechanical system 84 to rotate thereby causing the stop/lock 82 to move from the locked position (FIG. 5) to the unlocked position (FIG. 6) and thereby allowing the door 34 to move from the closed position. As will be appreciated from an understanding of this invention disclosure, and upon expiration of the free rotation of the operating shaft assembly 62, continued rotation of the operating shaft assembly 62 imparts actuation of the drive mechanism 70 (FIGS. 5 and 6) resulting in sequential linear movement of the door 34 from the closed position.

According to this invention disclosure, there is provided a door lock indicator apparatus 130 readily visible from at least one side of the railcar 10 (FIG. 1) for visually indicating an unlocked/locked condition of the lock assembly 80 (FIGS. 5 and 6). In the illustrated embodiment, the door lock indicator apparatus 130 operates in conjunction with the position and operation of the stop/lock 82 of the lock assembly 80 (FIGS. 5 and 6).

In preferred form, the door lock indicator apparatus 130 includes a first instrumentality 132 arranged in a fixed position on the railcar 10 (FIG. 1). As shown in FIG. 8, the first instrumentality 132 fixedly extends from the gate assembly frame 32. In a preferred embodiment, the first instrumentality 132 defines a fixed visible plane P and, in one form, has a free end. In the exemplary embodiment, the first instrumentality 132 has a generally horizontal disposition defining a generally horizontal plane. Toward the free end 136 thereof, the first instrumentality 132 defines an opening 138 or slot.

Preferably, the door lock indicator apparatus 130 also includes a second pivotally movable instrumentality 142 arranged on railcar 10 (FIG. 1). The second instrumentality 142 is connected to and pivotally moves with the rock shaft 86 of the mechanical system 84 which likewise operates the lock assembly 80. As such, the second instrumentality 142 pivotally moves in response to movement of and with the stop 82 of lock assembly 80.

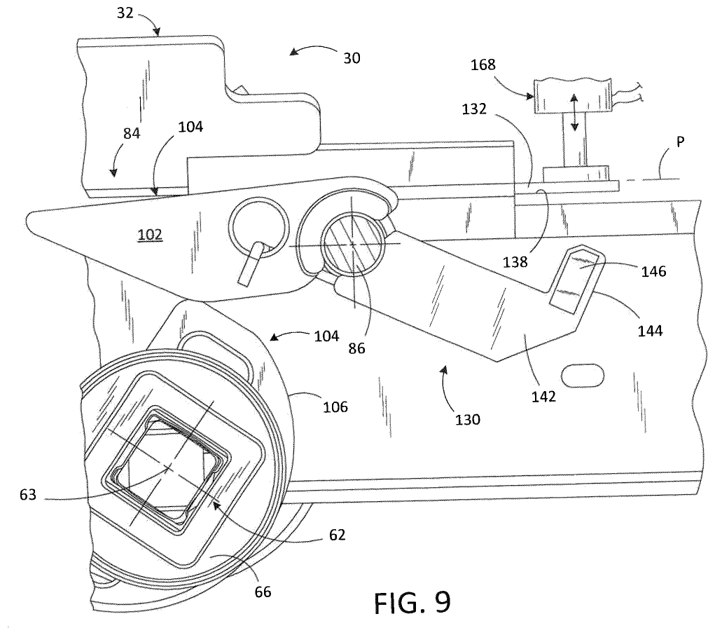

In a preferred embodiment shown by way of example in FIGS. 8 and 9, and preferably toward a free end thereof, the second instrumentality 142 has an indicator portion, appendage or flag 144 which moves into and out of an interengaging relationship with the first instrumentality 132 to visually indicate the condition of the door lock/stop 82 on the railcar 10. Moreover, at least the appendage 144 on the second instrumentality 142 is preferably provided with a highly visible coloration 146 to enhance the visibility of the indicator portion or appendage 144 penetrating or permeating the plane P defined by the first instrumentality 132.

When the stop 82 of the door lock assembly 80 is in a locked condition (FIG. 6), portions of the first and second instrumentalities 132 and 142, respectively, of the door lock indicator apparatus 130 are configured and designed to be arranged in a interengaging relationship from each other. The highly visible colorization 146 on the second instrumentality 142 will enhance the visual indication that the stop 82 of lock assembly 80 is in a closed or locked position as by the flag or appendage portion 144 on the second instrumentality 142 penetrating or permeating through the plane of the first instrumentality 132 whereby providing a clearly visible indication the stop/lock 82 of door lock assembly 80 is disposed inhibit the door 34 of the gate assembly 30 from moving toward and an open position.

Conversely, when the door 34 of the gate assembly 30 is to moved from a closed position, the stop/lock 82 of the door lock assembly 80 must be moved to an unlocked condition (FIG. 6.) As mentioned, when the door 34 of the gate assembly 30 is to be purposefully moved from its closed position, the operating shaft assembly 62 is purposefully rotated about axis 63. As discussed, initial rotation of the operating shaft assembly 62 causes the rockshaft 86 of the mechanical system 84 to rotate thereby resulting in the stop/lock 82 moving from the locked position (FIG. 5) to the unlocked position (FIG. 6) and thereby allowing the door 34 to move from the closed position.

Turning to FIG. 9 and as a result of the rockshaft 86 of the mechanical system 84 rotating, the second instrumentality 142 pivots thus removing the flag portion 144 of the second instrumentality 142, from its penetrating or permeating (“interengaging”) relationship relative to the plane defined by the first instrumentality 132 so as to visually indicate the lock assembly 80 is in an unlocked condition. As will be appreciated from an understanding of this invention disclosure, the highly visible colorization 146 on the second instrumentality 142 will enhance the visual indication the stop/lock 82 of lock assembly 80 is in in place to allow for linear movement of the door 34 to move toward and open position. Moreover, casual inspection of the door lock indicating apparatus 130 will also provide a clear indication of the condition of the door lock assembly 80.

According to another aspect of this invention disclosure, there is provided an indicator system 160 for providing a further indication/signals of whether the door lock assembly 80 (FIGS. 5 and 6) is in either a locked or unlocked condition. Notably, system 160 is capable of providing a further visual indication or digital signal of the condition of the door lock assembly 80 to a location disposed either proximate to or remote from the position of the hopper car 10.

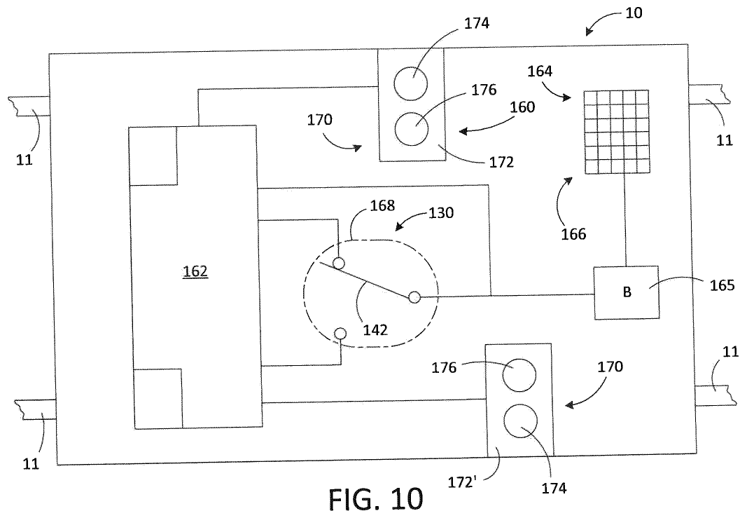

In the form shown in FIG. 10, the indicator system 160 includes electric circuitry, generally indicated by reference number 162, connected to a power source 164. In the exemplary embodiment, the power source 164 includes a conventional rechargeable battery 165 carried on car 10. Preferably, the power source 164 is connected to a solar energy panel 166 suitably mounted on car 10. In the form illustrated by example in FIG. 10, the electric circuitry 162 includes the door lock indicator apparatus 130 and sensor technology 168 (FIGS. 8 and 9) for monitoring the condition of the door lock assembly 80 (FIGS. 5 and 6) and for controlling operation of an illuminable indicator 170 as a result of signals received from the door lock indicator apparatus 130 and sensor technology 168 indicative of the condition of the lock/stop 82 of the door lock assembly 80.

In operation, and besides using the visual appearance of the first and second instrumentalities 132 and 142, respectively, relative to each other, sensor 168 provides signals to the illuminable indicator 170 as a result of the movement of the door lock assembly 80 (FIGS. 5 and 6) between locked and unlocked conditions. In effect, the sensor technology 168 detects whether the stop/lock 82 of the door lock assembly 80 (FIGS. 5 and 6) is in a locked/unlocked position. That is, sensor technology 168 produces a first signal only when the lock/stop 82 is in one, i.e. locked condition, and the sensor technology 168 produces a second signal only when the stop/lock 82 is in another condition, i.e., unlocked condition. As such, any guessing by an operator of whether the door locking assembly 82 is locked or unlocked, is eliminated.

In one form, the sensor technology 168 is of the type manufactured by TopWorx and sold under Model Number 36-13318AZ and which is designed to monitor whether the door lock assembly 80 (FIGS. 5 and 6) is in a position wherein at least the flag portion 144 of the second instrumentality 142 has permeated or penetrated the fixed plane P defined by the first instrumentality 132 so as to indicate the locked/unlocked condition/position of the stop/lock 82. Of course, other types and/or models of sensor technology including proximity switches/sensors capable of developing signals which indicate or divulge a location of one member relative to another and which can be used in combination with the indicator system 160 without detracting or departing from the spirit and scope of this invention disclosure.

In a preferred embodiment, the illuminable indicator or display 170 for system 160 provides a signal amplifier through mechanical means regarding the current condition of a door lock on a railroad hopper car. In one embodiment, the illuminable indicator or display 170 for system 160 includes at least two illuminable displays 172, 172′ (FIG. 10) for visually indicating the condition of the door lock assembly 80. In one form, the displays 172, 172″are mounted to opposed sides of the railcar 10. As such, the condition of the door locking assembly 80 for each gate assembly 30 (FIG. 1) can be distantly viewed from either side of the car 10.

Preferably, the illuminable displays 172, 172′ are identical in form and function relative to each other and, thus, only display 172 will be described in detail. Each display is electrically powered and controlled by signals from the electrical circuitry 162, the sensor technology 168 and the door lock indicator apparatus 130 (FIGS. 5 and 6) to indicate whether the stop/lock 82 of the associated gate assembly 30 is in a locked or unlocked condition. In one form, the indicator or display 172 includes at least one light 174 operable in either of two states for indicating whether the stop/lock 82 of the associated gate assembly 30 is in a locked or unlocked condition. Preferably, however, and as indicated in FIG. 10, each display includes two lights 174 and 176. In this embodiment, light 174 emits illumination when the lock/stop 82 of the door lock assembly 80 is in one condition, i.e. a locked condition, and with light 176 emitting illumination when then stop/lock 82 of the door lock assembly 80 is in a different condition, I,e., an unlocked condition.

In one form, a first color, i.e, red, is emitted from each illuminable indicator or display 172, 172′ when the first light 174 is illuminated, and wherein a second color, i.e, green, is emitted from each illuminable indicator or display 172, 172′ when the second light 174 is illuminated.

Another aspect of this invention disclosure involves a method for indicating the status of a door lock 82 on a railcar gate assembly 30 having a horizontally slidable door 34 movable between open and closed positions on a railcar 10. The door lock 82 is displaceable between a locked condition, wherein the door lock 82 inhibits the door 34 from sliding toward the open positron, and an unlocked condition. In the unlocked condition, the door lock permits the door 34 to be slidably moved toward the open position.

The method for indicating the status of a door lock 82 on a railcar gate assembly 30 comprises the steps of: displacing the stop/lock 82 from a locked condition in timed relation with moving the door 34 from the closed position through a drive mechanism 70 operably coupled to the door 34. This process furthermore involves: providing a first instrumentality 132 on a frame 32 of the gate assembly 30 so as to define a rigid plane P. In the illustrated embodiment, the rigid plane P defined by the first instrumentality 132 is a generally horizontal plane. Furthermore, the process involves the step of: pivotally extending and retracting a flag portion 146 of a second instrumentality from one side of the plane P defined by the first instrumentality 132 to an opposite side of the plane P defined by the first instrumentality 132 in response to displacement of the door lock 82.

The process further involves the step of: providing the second instrumentality 142 with the flag portion or appendage 146 movable into and out of an interengaging or permeating relationship with the plane P of the first instrumentality 132 to visually indicate the unlocked/locked condition of the door lock 82 on the railcar. Preferably, the process further involves the step of: providing a highly visible coloration 145 on the appendage 146 of the second instrumentality 142 to enhance the visibility thereof.

According to a preferred process, the first instrumentality 132 of the door lock indicator apparatus 130 fixedly extends from a frame 32 of the gate assembly 30 and has a free end136. In one form, the preferred process also includes the step of: operably coupling the mechanical system 100 to and positively pivoting the second instrumentality 142 of the door lock indicator apparatus 130 relative to the first instrumentality 132 as a function of the locked/unlocked condition of the door lock/stop 82 while concurrently operating the door lock/stop 82.

Preferably, the method of indicating the status of a door lock/stop 82 on a railcar with a gate assembly 30 further involves the step of: providing an electrically powered illuminable system 160 on the railcar 10 for indicating whether the door lock/stop 82 is in a locked condition or an unlocked condition. Wherein, this step also involves providing electrical circuitry 152 operated as a function of the pivotal position of the second instrumentality 142 of the door lock indicator apparatus 130 and connected to an illuminable indicator 170. In one form, the process further involves: providing a solar energy panel 166 on the railcar 10 to power source 164 connected to the illuminable indicator 170 and circuitry electrically powering the illuminable indicator 170.

From the foregoing, it will be observed numerous modifications and variations for visually indicating the condition of a door stop/lock on a railcar discharge gate assembly can be made and effected without detracting or departing from the true spirit an novel concepts of this invention disclosure. Moreover, is will be appreciated, the present invention disclosure is intended tom set forth exemplifications which are not intended to limit the disclosure to the specific embodiments illustrated and discussed. Rather, this disclosure is intended to cover by the appended claims all such modifications and variations as fall within the spirit and scope of the appended claims.

What is claimed:

1. A door lock indicator apparatus for visually indicating an unlocked/locked condition of a door lock on a railcar having a sliding door movable between an open position and a closed position as a function of the condition of said door lock, said door lock indicator apparatus comprising:
a first instrumentality arranged in a fixed position on said railcar;
a second pivotally movable instrumentality on said railcar, with portions of said first and second instrumentalities having an interengaging relationship with each other when said door lock is in a locked condition, and with said portions of said first and second instrumentalities having a non-engaging relationship with each other in response to said door lock being pivotally moved to an unlocked condition; and
a drive mechanism for moving said door lock between the open position, with said drive mechanism being further operably coupled to and for positively pivoting said second instrumentality relative to said first instrumentality as a function of the locked/unlocked condition of said door lock.

2. The door lock indicator apparatus according to claim 1 wherein said second instrumentality includes an appendage movable into and out of the interwoven relationship with said first instrumentality to visually indicate the unlocked/locked condition of the door lock on said railcar.

3. The door lock indicator apparatus according to claim 2, further including a highly visible coloration disposed on the appendage of said second instrumentality to enhance the visibility thereof

4. The door lock indicator apparatus according to claim 1 wherein said first instrumentality fixedly extends from a frame on said railcar and has a free end,

5. The door lock indicator apparatus according to claim 1 wherein the drive mechanism operably coupled to and for positively pivoting said second instrumentality relative to said first instrumentality operates as a function of movement of said door.

6. A door lock indicator apparatus for providing a visual indication of a condition of a door lock forming part of a gate assembly on a railcar, wherein said railcar has a frame, a hopper defining a discharge opening through which lading is discharged from said hopper, and wherein a door on said gate assembly is movable, under the operable influence of a manually operated and rotatable drive mechanism, between a closed position, wherein said door blocks the discharge of lading through said discharge opening, and an open condition, wherein lading is permitted to be discharged from said hopper through said discharge opening, with said door lock being movable to a locked position wherein said door lock holds said door in the closed position until said door lock is manually moved to an unlocked condition whereby allowing said door to be moved toward an open position, with said apparatus comprising:
a first instrumentality extending from said frame, with said first instrumentality defining a visible plane;
a second instrumentality pivotally movable in response to rotation of said manually operated and rotatable drive mechanism, with said second instrumentality being pivotal between a first position, wherein an indicator portion of said second instrumentality passes through the plane of said first instrumentality to visually indicate when said door lock is in the unlocked position, and a second position, wherein the indicator portion of said second instrumentality is removed from the plane of said first instrumentality to visually indicate said door lock is in the locked position.

7. The door lock indicator apparatus according to claim 6, further including a highly visible coloration disposed on the indicator portion of said second instrumentality to enhance the visibility thereof.

8. The door lock indicator apparatus according to claim 6 further including an electrical system including an electrically powered illuminable indicator arranged on the railcar for indicating whether said door lock is in said locked condition or said unlocked condition and electrical circuitry operated as a function of the pivotal position of said second instrumentality and connected to said illuminable indicator.

9. A method of indicating status of a door lock on a railcar gate assembly having a horizontally slidable door which moves between open and closed positions on a railcar, with said door lock being displaceable between a locked condition, wherein said door lock inhibits said door from sliding toward the open positron, and an unlocked condition, wherein said door lock permits said door to be slidably moved toward the open position, comprising the steps of:
displacing said door lock from a locked condition in timed relation with moving said door from the closed position through a drive mechanism operably coupled to said door;
providing a first instrumentality on a frame of the gate assembly so as to define a visible plane; and
extending and retracting a flag portion of a second instrumentality from one side of said visible plane to an opposite side of said visible plane in response to displacement of said door lock.

10. The method of indicating status of a door lock on a railcar gate assembly according to claim 9 further including the step of
providing a highly visible coloration on the flag portion of said second instrumentality to enhance the visibility thereof.

11. The method of indicating status of a door lock on a railcar gate assembly according to claim 9 wherein said first instrumentality fixedly extends from a frame on said railcar and has a free end.

12. The method of indicating status of a door lock on a railcar gate assembly according to claim 9 wherein the drive mechanism operably coupled to and for positively pivoting said second instrumentality relative to said first instrumentality as a function of the locked/unlocked condition of said door lock also operates said door on said railcar.

13. The method of indicating status of a door lock on a railcar gate assembly according to claim 9 further including the step of:
providing an electrically powered illuminable indicator arranged on the railcar for indicating whether said door lock is in said locked condition or said unlocked condition and electrical circuitry operated as a function of the pivotal position of said second instrumentality and connected to said illuminable indicator.

14. The method of indicating status of a door lock on a railcar gate assembly according to claim 13 further including the step of:
providing a solar energy panel on said railcar to power a battery connected to said illuminable indicator and the circuitry electrically powering the illuminable indicator.
